(19) United States
(12) Patent Application Publication
(10) Pub. No.: US 2022/0235806 A1
(43) Pub. Date: Jul. 28, 2022

(54) RIVETING METHOD AND A RIVETING STRUCTURE

(71) Applicant: Penn Engineering & Manufacturing Corp., Danboro, PA (US)

(72) Inventors: Qiang Sun, Novi, MI (US); Shengbao Cai, Shanghai (CN)

(21) Appl. No.: 17/382,903

(22) Filed: Jul. 22, 2021

(30) Foreign Application Priority Data
Jan. 22, 2021 (CN) CN2021100934143

(51) Int. Cl. F16B 19/06; B21J 15/02

(52) U.S. Cl. CPC F16B 19/06; B21J 15/44; B21J 15/02

(57) ABSTRACT

The present invention discloses a riveting method and a riveting structure. The riveting method comprises providing a plate having a first side and a second side opposite to the first side; forming a wall portion on the first side of the plate, the wall portion having a first recessed area at its first side and a second recessed area at its second side opposite to the first side; placing the fastener in the first recessed area so that the fastener is adjacent to the first side of the wall portion; and applying a force to the wall portion from the second side of the wall portion so that the wall portion is deformed so as to at least partially enclosed the fastener. This technical solution can avoid unwanted indentation on the back of the plate.

### CROSS-REFERENCE TO RELATED APPLICATIONS

This is a non-provisional patent application related to Chinese patent application serial number CN2021100934143 filed Jan. 22, 2021 priority from which is hereby claimed.

### FIELD OF THE INVENTION

The present invention relates to the technical field of riveting, in particular to a riveting method and a riveting structure.

### BACKGROUND OF THE INVENTION

There are many ways to mount fasteners and other parts onto a plate. The commonly used methods are pressing riveting and gluing.

During the pressing riveting process, an axial force applied to the fastener also acts on the plate at the same time. Due to a small thickness of the plate, indentation may be formed on an opposite side of the plate from the fastener. For products that require high appearance quality and mechanical properties of the riveting structure, the indentation may cause the product to be defective. Gluing can avoid the unwanted indentations on the plate, however the gluing may pollute the environment, and the gluing structure has poor weather resistance. When the temperature exceeds 80° C., the mechanical properties of the gluing structure may drop significantly. There is therefore a need in the art for an improved riveting structure and method.

### SUMMARY OF THE INVENTION

In order to overcome the defects in the prior art, the present invention provides a riveting method and a riveting structure which are used to solve the above-mentioned technical problems.

In one aspect of the present application, a riveting method for riveting a fastener onto a plate is provided. The riveting method comprises the following steps:

providing a plate having a first side and a second side opposite to the first side;

forming a wall portion on the first side of the plate, the wall portion defining a first recessed area at its inward side and a second recessed area at its outward side opposite to the inward side;

placing the fastener into the first recessed area so that the fastener is adjacent to the first side of the wall portion; and

applying a force to the wall portion from the outer side of the wall portion, so that the wall portion is deformed so as to at least partially enclose the fastener.

In some embodiments, the step of forming a wall portion on the first side of the plate comprises:

forming a blind hole on the first side of the plate; and

forming a groove outside of the blind hole to form the wall portion between the blind hole and the groove, wherein the blind hole and the groove form at least a part of the first and second recessed areas.

In some embodiments, the applied force is not perpendicular to a tangent plane of the plate at least at the wall portion.

In some embodiments, the applied force has an angle of 0° to 45° with the tangent plane of the plate at the wall portion.

In some embodiments, the step of applying a force to the wall portion comprises:

applying respective forces to the wall portion discontinuously or continuously during a circumferential movement of a tool for applying such forces along the wall portion.

In some embodiments, the step of applying a force to the wall portion comprises:

applying respective forces to the wall portion discontinuously or continuously in an order from a base of the wall portion to a top of the wall portion or from the top of the wall portion to the base of the wall portion.

In some embodiments, the step of applying a force to the wall portion comprises:

applying at a first level of the wall portion respective forces to the wall portion discontinuously or continuously during a first circumferential movement of a tool for applying such forces along the wall portion; and

applying at a second level of the wall portion respective forces to the wall portion discontinuously or continuously during a second circumferential movement of the tool for applying such forces along the wall portion.

In some embodiments, the step of applying a force to the wall portion comprises:

using a tool to apply a first force to the wall portion so that a deformed portion of the wall is recessed toward the fastener; and

placing the tool in the deformed portion against the wall portion and moving the tool from one side of the deformed portion to the other side of the deformed portion along the wall portion, wherein the tool abuts the wall portion.

In some embodiments, the tool has a first axis, wherein the tool further has a cross section perpendicular to the first axis, and the cross section is either a regular cross section or an irregular cross section.

In some embodiments, the regular cross section is one or a combination of a circular cross section, an elliptical cross section, and a polygonal cross section.

In some embodiments, the tool has a first axis, wherein the tool is configured to rotate about the first axis during a movement of the tool along the wall portion, so as to avoid or reduce a friction between the tool and the wall portion.

In some embodiments, a trajectory of the first axis is a regular trajectory or an irregular trajectory during the movement of the tool along the wall portion.

In some embodiments, the regular trajectory is one of a circular, elliptical, polygonal, or zigzag shape.

In some embodiments, the recessed area is formed by one of the following methods: machine tool machining, powder metallurgy technology, 3D printing, electric discharge machining, forging and casting.

In some embodiments, the recessed area has a regular shape or an irregular shape.

In some embodiments, the regular shape is one or a combination of a circular, elliptical, or polygonal shape.

In some embodiments, the step of applying a force to the wall portion comprises: using a tool to apply forces to the wall portion, wherein the tool has a plurality of abutting portions for abutting the wall portion, and the plurality of abutting portions are distributed around the wall portion at an equal interval or unequal intervals.

In another aspect of the present application, a riveting structure is provided, and the riveting structure comprises a plate and a fastener, wherein the riveting structure is prepared by one of the riveting methods mentioned above.

In some embodiments, the fastener comprises a head and a shaft that are connected to each other and the head is configured to be placed in the recessed area so as to be enclosed by the wall portion after the wall portion is deformed.

In some embodiments the head and/or the side wall of the shaft has a torque-resistant structure.

In some embodiments the head and/or the shaft perpendicular to an axis of the fastener has a regular-shaped cross section or an irregular-shaped cross section.

In some embodiments the regular shape is one or a combination of a circular, a polygonal, or an elliptical shape.

In some embodiments the plate comprises a plastic material.

The present invention has at least one or more of the following beneficial technical effects:

1. During the riveting process, a wall portion is pushed in the direction toward the fastener so the generation of burrs can be avoided or reduced.

2. In the riveting method, a blind hole for accommodating a fastener is formed on the plate, and an annular groove surrounding the blind hole is provided outside of the blind hole, so that a surrounding wall portion with a certain thickness is formed between the blind hole and the annular groove. Then, a specific force is applied to the wall portion at an angle α between the force and the axis of the blind hole, so that the deformation of the wall is mainly due to the force perpendicular to the axis of the blind hole rather than the force parallel to the axis of the blind hole. That is, the force parallel to the axis of the blind hole which is applied to the wall (or the metal plate) is very small, and therefore unwanted indentation of the plate can be avoided.

3. The riveting structure with a fastener has good torque resistance and pull-out resistance performance.

In order to make the above-mentioned and other objectives, features and advantages of the present invention more obvious and clear, the following description will specifically refer to preferred embodiments in combination with the accompanying drawings, to describe in detail as follows.

### BRIEF DESCRIPTION OF THE FIGURES

In order to explain the embodiments of the present invention or the technical solutions in the prior art more clearly, the following will briefly illustrate the drawings that need to be used in the description of the embodiments or the prior art. Obviously, the drawings in the following description are only some embodiments of the present invention. For those skilled in the art, other drawings can be obtained based on these drawings without creative works.

FIG. 1 shows a schematic diagram of the configuration of a riveting structure before riveting according to an embodiment of the present invention;

FIG. 2 shows a force analysis on a wall portion according to an embodiment of the present invention;

FIG. 3A shows a cross-sectional view of a riveting operation by a tool according to another embodiment of the present application;

FIG. 3B shows a cross-sectional view of a riveting operation by a tool according to another embodiment of the present application;

FIGS. 4A to 4C show some examples of tools;

FIGS. 5A and 5B show some examples of blind holes and grooves;

FIGS. 6A to 6F show the configuration of some fasteners adapted for being riveted to a plate.

The reference numerals of the above-mentioned drawings: 100—a metal plate; 110—a blind hole; 120—a groove; 130—a wall; 200—a fastener; 210—a head; 220—a shaft; 300—a tool.

### DETAILED DESCRIPTION OF THE INVENTION

The technical solutions in the embodiments of the present invention will be described clearly and completely in combination with the accompanying drawings in the embodiments of the present invention. Obviously, the described embodiments are only a part of the embodiments of the present invention rather than all of the embodiments. Based on the embodiments of the present invention, all other embodiments obtained by those skilled in the art without creative works shall belong to the scope of the present invention.

The inventor of the present application found that the reason why riveting a fastener onto a plastic panel (e.g. a deformable metal panel) using existing methods may cause defects such as indentations or burrs on the plate is that the riveting method may apply excessive force in a normal direction of the plate, and this force may cause the plate to undesirably deform at the riveting point.

The inventor found that, if a wall portion between two recessed areas which are pre-formed on a plastic panel and a force is then applied to the wall portion in a tangential direction of the plastic panel or other non-normal directions to deform the wall portion, the deformed wall portion can constrain the fastener within one of the recessed area adjacent to the wall portion. This way of applying force can greatly reduce a force component applied to the plate in the normal direction of the plate, thereby effectively reducing or avoiding the indentations or burrs produced during the riveting process.

According to the above-mentioned inventive concept, in some embodiments, a riveting method for riveting a fastener onto a plate is provided. The riveting method comprises the following steps: providing a plate having a first side and a second side opposite to the first side; forming a wall portion on the first side of the plate, and the wall portion having a first recessed area at its first side and a second recessed area at its second side opposite to the first side; placing the fastener in the first recessed area so that the fastener is adjacent to the first side of the wall portion; and applying a force to the wall portion from the second side of the wall portion, so that the wall portion is deformed so as to at least partially enclose the fastener. In some embodiments, the recessed area on one side of the wall portion may be a blind hole, which is adapted for accommodating the fastener to be riveted; the recessed area on the other side of the wall portion may be a groove, which surrounds a blind hole, for example, and has a space which is adapted for inserting a tool therein to apply a force to the wall portion. In other embodiments, one side of the wall portion may be a groove, and the other side of the wall portion may be a blind hole. A tool may be inserted into the blind hole and a force is applied to the wall portion to rivet the fastener accommodated in the hole (the groove may be, for example, an annular groove, and the fastener may be a fastener with a through hole). In some embodiments, the blind hole and the groove may be a part of the recessed area, that is, the shape of the fastener may not exactly match the recessed area. It can be understood that the specific shape of the recessed structure can be designed and modified according to the shape of the fastener. In the following embodiments of the present application, the recessed structures on both sides of the wall portions are exemplarily described as a blind hole and a groove, but those skilled in the art can understand that the present application is not limited to this configuration.

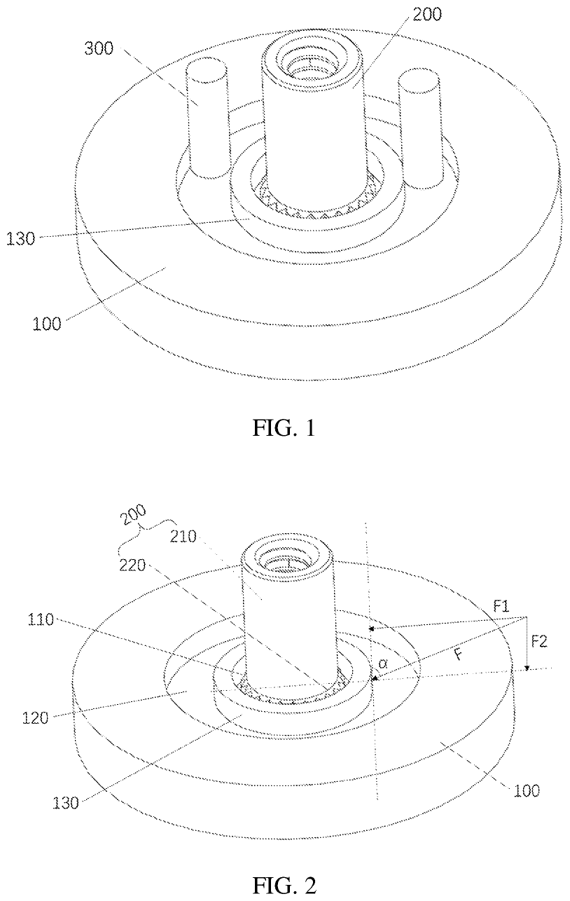

As shown in reference with FIGS. 1 and 2, the riveting method of this embodiment is used for riveting a fastener 200 onto a plate 100. When the plate 100 is thinner than 3 mm, the advantages of the riveting method of this embodiment are particularly obvious. However, those skilled in the art can understand that the riveting method of the present application can be used for riveting a fastener onto a plate having a larger thickness. In this embodiment, the riveting method comprises the following steps: forming a blind hole 110 on the plate 100; and forming an annular groove 120 on the side of the plate 100 with the blind hole 110, wherein the groove 120 is provided outside of the blind hole 110 to form the wall portion 130 between the annular groove 120 and the blind hole 110. The dimensions of the structures are selected so that wall portion 130 has a desired thickness.

During installation the fastener 200 is placed into the blind hole 110 and a force is applied to the side wall of the wall portion 130 toward the groove 120, so that the wall portion 130 is deformed (deformation is generated) toward the fastener 200 to enclose the portion of the fastener 200 located in the blind hole 110. In some embodiments, the applied force F has an angle α from the axis of the blind hole 110 (as shown in FIG. 2), thereby increasing the effect of the force F1 perpendicular to the axis of the blind hole 110 on the wall portion 130 and reducing the effect of the force F2 parallel to the axis of the blind hole 110. It can be understood that the angle α may be greater than 0 degree but less than or equal to 90 degrees, that is, the applied forces F are not perpendicular to a tangent plane of the plate 100. In the case where the plate is a flat plate, the tangent plane of the plate is the plane where the plate is located. In the case where the plate is not a flat plate, the above-mentioned tangent plane of the plate refers to the tangent plane of the plate at the position where the force for riveting is applied. Preferably, the angle α may be 45 degrees to 90 degrees, that is, the angle of the applied force from the tangent plane of the plate at the wall portion is 0 degree to 45 degrees.

With the above technical solution, the riveting method of this embodiment can form the blind hole 110 for accommodating the fastener 200 on the plate 100, and form the groove 120 outside of the blind hole 110, so that a surrounding wall portion 130 with a certain thickness is formed between the blind hole 110 and the groove 120, and then a force of a specific orientation is applied to the wall portion 130. As such, the deformation of the wall portion 130 is mainly due to the force F1 perpendicular to the axis of the blind hole 110 rather than the force F2 parallel to the axis of the blind hole 110, that is, the force F2 parallel to the axis of the blind hole 110 which is applied to the wall portion 130 (or the plate 100) is small, and therefore, the indentation on the plate 100 can be reduced or avoided.

Preferably, the applied force which is applied to the wall portion 130 in this embodiment can be completely perpendicular to the axis of the blind hole 110. In other words, the above-mentioned angle α may be 90°. At this time, the wall portion 130 and the plate 100 may not be subject to any axial force, so as to further avoid the indentation on the plate 100.

Specifically, in the riveting method of this embodiment, forces may be applied to the wall portion 130 discontinuously (that is, stepwise) or continuously during a circumferential movement of a tool for applying such forces along the wall portion 130, or forces may be applied to different portions of the wall portion 130 discontinuously or continuously in an order from a base of the wall portion 130 to a top of the wall portion 130 (or from the top of the wall portion 130 to the base of the wall portion). Preferably, the tool 300 can be used to apply forces to the wall portion 130 during a circumferential (along the perimeter) movement of the tool 300 for applying such forces along the wall portion 130 for multiple times at the same level of the wall portion 130 (assuming that the metal plate is placed horizontally on the operation platform). After the force applying operation for a circumference of the wall portion 130 at a level is completed, the tool 300 is then moved to another level of the wall portion 130, and forces are applied to the wall portion 130 during another circumferential movement of the tool 300 for applying such forces along the wall portion 130 for multiple times at the another level. In other words, in the riveting method of this embodiment, the deformation of the wall portion 130 can be achieved by a combination of multiple forces which are applied discontinuously or continuously during circumferential movements of a tool for applying such forces along the wall portion 130 at different levels of the wall portion (e.g., in the direction from a base of the wall portion to a top of the wall portion).

It can be understood that the angles of the applied forces F which are applied at different levels relative to the axis direction can be different or the same, and the magnitudes of the applied forces F which are applied at different levels can also be the same or different. Preferably, the magnitude of the force F1 of each applied force F perpendicular to the axis of the blind hole 110 can maintain the same, so that the force can be uniformly applied at different positions of the wall portion.

Taking three times as an example, the tool 300 is first inserted into the groove 120 for a distance of L1. At this level, the tool 300 is used to apply forces to the wall portion 130 during a circumferential movement of the tool 300 for applying such forces along the wall portion 130 for multiple times. Next, continue to insert the tool 300 into the groove 120 for a distance of L2. At this time, the actual depth of the tool 300 into the groove 120 is L1+L2. At this level, the tool 300 is used to apply forces to the wall portion 130 during another circumferential movement of the tool 300 for applying such forces along the wall portion 130 for multiple times. Next, continue to insert the tool 300 into the groove 120 for a distance of L3. At this time, the actual depth of the tool 300 into the groove 120 is L1+L2+L3. At this level, the tool 300 is used to apply forces to the wall portion 130 during a further circumferential movement of the tool 300 for applying such forces along the wall portion 130 for multiple times.

With the above technical solution, the riveting method of this embodiment can achieve deformation of the wall portion 130 by applying small forces to the wall portion 130 for multiple times. The method of applying small forces for multiple times can further reduce the force F2 each time the force is applied in the direction parallel to the axis of the blind hole 110 to the wall portion 130, and therefore, the indentation on the metal plate 100 can be further avoided.

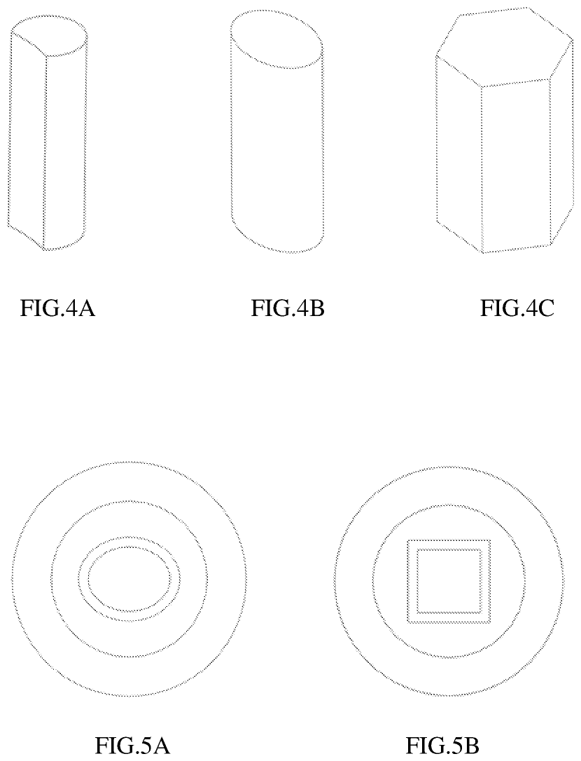

The tool 300 in this embodiment has a first axis (in FIG. 1, the first axis of the tool 300 is the central axis of the cylindrical tool 300), and the tool 300 also has a non-circular cross section or a circular cross section perpendicular to the first axis. In some other embodiments, the tool may have an elongated shape similar to the tool 300 as shown in FIG. 1, and the first axis may be the central axis of the elongated tool. Further, the non-circular cross-section may include a regular cross-section such as an elliptical cross-section, polygonal cross-section, or a combination thereof, and may also include an irregular-shaped cross-section; these cross-sections may be symmetrical or asymmetrical cross-sections. In other words, a shape corresponding to the cross section of the tool 300 perpendicular to the first axis may be non-circular or circular. When the cross-section is non-circular, it may be regular such as an ellipse, a polygon (for example, a triangle, a quadrilateral, a pentagon, a hexagon, etc.), or a combination thereof, or may be irregular. FIGS. 4A to 4C show some examples of tools, and it can be seen that various regular or irregular cross-sectional shapes are adopted. For example, FIG. 4A is an irregular cross section with a part of a circular cross section cut away, FIG. 4B is an elliptical cross section, and FIG. 4C is a regular six deformed cross section.

More specifically, in the above-mentioned process of applying forces to the wall portion 130 during a circumferential movement of the tool 300 for applying such forces along the wall portion 130 for multiple times, there may be several methods as follows. The first method: the tool 300 can be used to apply forces to the wall portion 130 for multiple times in the thickness direction of the wall portion 130 (in this embodiment, the thickness of the wall portion 130 refers to the distance between the side of the wall portion 130 facing toward the annular groove 120 and the side of the wall portion 130 facing toward the blind hole 110). In the process of applying forces for multiple times, the tool 300 may not always keep in contact with the wall portion 130. The second method: initially the tool 300 can be used to apply a first force to the wall portion 300 in the thickness direction of the wall portion 130, so that a deformed portion recessed toward the fastener 200 is generated on the wall portion 130; then, the tool 300 is placed in the deformed portion and abut against the wall portion 130; then, the tool 300 is moved from one side of the deformed portion to the other side of the deformed portion to move tool 300 for a circumference of the wall portion 130 to apply forces along the wall portion 130, and the tool 300 always abuts against the wall portion 130 during the movement to apply the force in the thickness direction to the wall portion 130. It can be seen that, in the second method, the tool 300 revolves around the wall portion 130, and the tool 300 always abuts against the wall portion 130 during the revolution to apply forces to the wall portion 130.

Furthermore, referring to FIG. 1, in some embodiments, the tool 300 rotates about a first axis during a movement of the tool 300 along the wall portion 130, so as to avoid or reduce a friction between the tool 300 and the wall portion 130. In other words, while the tool 300 revolves around the wall portion 130, it also rotates about its own first axis (that is, self-rotation is generated). As such, the friction between the tool 300 and the wall portion 130 can be changed from a sliding friction to a rolling friction, which is beneficial to reduce friction and reduce the risk of generating debris on the wall portion 130. In some embodiments, the tool 300 may include one or more cylindrical abutting portions, such as the two cylindrical abutting portions shown in FIG. 1, which are symmetrically distributed on two opposite sides of the wall portion 130; optionally, the tool 300 may also include more abutting portions, such as 3, 4 or more, which may be distributed around the wall portion 130 at an equal interval or unequal intervals, such as on the two opposite sides of the wall portion. It can be understood that the distances between each two of the plurality of cylindrical abutting portions of the tool 300 can be modified to adapt for the processing of the wall portions 130 having different outer diameters. In some embodiments, during a circumferential movement of the tool along the wall portion, a trajectory of the first axis is one or a combination of regular trajectories such as a circular, elliptical, polygonal, or zigzag shape or other irregular trajectories.

Specifically, the blind holes 110 and/or grooves 120, or the recessed areas of other shapes in this embodiment may be processed by mechanical or non-mechanical methods. FIGS. 5B and 5B show some examples of blind holes and grooves. In FIG. 5A, the blind hole may be of an elliptical shape and the groove may be of a circular shape, or in FIG. 5B, the blind hole may be of a square shape and the groove may be of a circular shape. Those skilled in the art can understand that, various shapes of blind holes and grooves and matching thereof can be used according to actual applications.

The riveting structure of this embodiment includes the above-mentioned plate 100 and the fastener 200, which are prepared by the riveting method of this embodiment.

Specifically, as shown in FIG. 1 and FIG. 2, the fastener 200 in this embodiment may comprise a head 210 and a shaft 220 that are connected to each other, and the head 210 is configured to be placed in the blind hole 110 so as to be enclosed by the above-mentioned wall portion. The side wall of the head 210 of the fastener 200 may be provided with splines. When the wall portion 130 is deformed toward the head 210 of the fastener 200, the material on the wall portion 130 can flow into the splines to make the plate 100 and the head 210 of the fastener 200 snapped together, so that the torque resistance of the fastener 200 can be improved. Alternatively, the head 210 of the fastener 200 perpendicular to an axis of the fastener may have a non-circular-shaped (such as, polygonal or elliptical shape) cross section. The head 210 with this shape can also improve the torque resistance when it is enclosed by the wall portion 130. The fastener 200 of this embodiment comprises a stud.

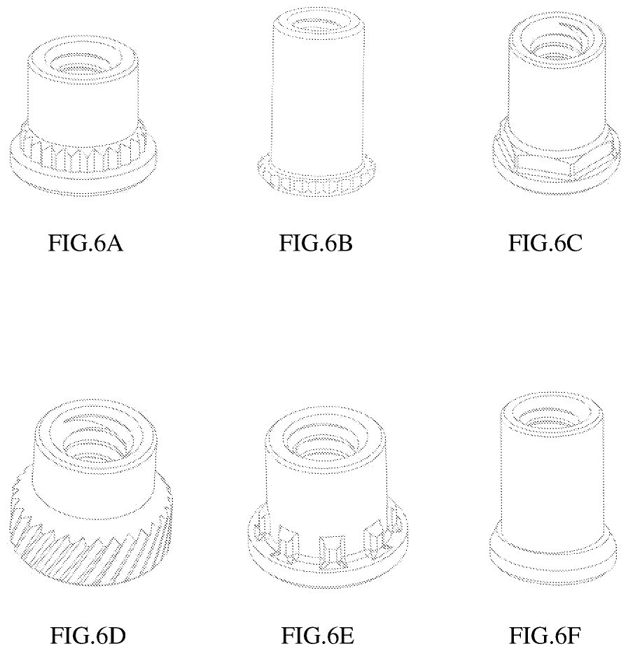

FIGS. 6A to 6F show the structures of some fasteners which are adapted for being riveted into a plate. Those skilled in the art can understand that other shapes of fasteners can also be used.

Still referring to FIGS. 1 and 2, specifically, the shape of the blind hole 110 in this embodiment is imitated with the shape of the head 210 of the fastener 200, and the shape of the groove 120 can also be imitated with the shape of the blind hole 110. As such, the thickness of the wall portion 130 can be more uniform, which is beneficial to improving the uniformity of the forces applied to the wall portion 130 and the deformation of the wall portion 130.

Specifically, the bottom of the blind hole 110 and/or the groove 120 in this embodiment is planar, which is beneficial for improving stability when placing the fastener 200.

Specifically, the material of the plate in this example is a plastic material, including metal and non-metal materials, such as low carbon steel, copper, aluminum, plastic, rubber, and so on.

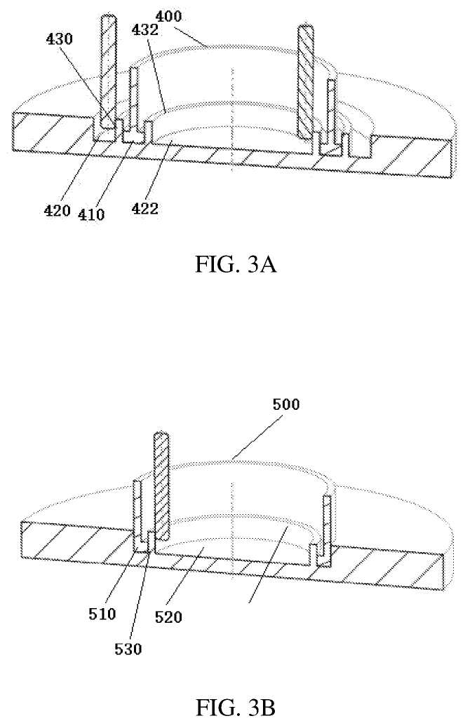

FIG. 3A shows a schematic cross-sectional view of a riveting operation by a tool according to another embodiment of the present application. The fastener 400 is provided in a first recessed area 410, and there is a recessed area on each side of the first recessed area. That is, a second recessed area 420 is located outside the first recessed area 410, and a third recessed area 422 is located inside the first recessed area 410. The first recessed area 410 and the second recessed area 420 define a first wall portion 430 located there between, and the first recessed area 410 and the third recessed area 422 define a second wall portion 432 located there between. The tool can be inserted into the second recessed area 420 and/or the third recessed area 422, and apply forces to the first wall portion and/or the second wall portion respectively, so as to generate a deformed portion on the first wall portion 430 and/or the second wall portion 432. These deformed portions may at least partially enclose a base of the fastener in the first recessed area 420, thereby riveting and fixing the fastener 400 therein.

FIG. 3B shows a schematic cross-sectional view of a riveting operation by a tool according to another embodiment of the present application. The fastener 500 is disposed in a first recessed area 510 on the substrate, and there is a second recessed area 520 inside the first recessed area 510. The first recessed area 510 and the second recessed area 520 define a wall portion 530 located there between. The tool can be inserted into the second recessed area 520, and apply forces outward to the wall portion 530, so as to generate a deformed portion on the wall portion 530. These deformed portions may at least partially enclose a base of the fastener 500 in the first recessed area 510, thereby riveting and fixing the fastener 500 therein.

In the present invention, specific examples are used to explain the principles and implementation of the present invention. The description of the above examples is only used to help to understand the method and main idea of the present invention; at the same time, for those skilled in the art, according to the idea of the present invention, there will be modifications in the specific implementations and applications. In summary, the content of the specification should not be construed as limiting the present invention.

What is claimed is:

1. A riveting method for riveting a fastener onto a plate, wherein the riveting method comprises the following steps:
providing a plate having a first side and a second side opposite to the first side;
forming a wall portion on the first side of the plate, the wall portion defining a first recessed area on a first inward side and a second recessed area on a second outer side opposite to the first side;
placing the fastener in the first recessed area so that the fastener is adjacent to the first side of the wall portion; and
applying a force to the wall portion from the second side of the wall portion so that the wall portion is deformed so as to at least partially enclose the fastener.

2. The riveting method of claim 1, wherein the step of forming a wall portion on the first side of the plate comprises:
forming a blind hole on the first side of the plate; and
forming a groove outside of the blind hole to form the wall portion between the blind hole and the groove, wherein the blind hole and the groove form at least a part of the first and second recessed areas, respectively.

3. The riveting method of claim 1, wherein the applied force is not perpendicular to a tangent plane of the plate at least at the wall portion.

4. The riveting method of claim 3, wherein the applied force has an angle of 0° to 45° with the tangent plane of the plate is at the wall portion.

5. The riveting method of claim 1, wherein the step of applying a force to the wall portion comprises:
applying respective forces to the wall portion either discontinuously or continuously during a circumferential movement of a tool for applying such forces along the wall portion.

6. The riveting method of claim 1, wherein the step of applying a force to the wall portion comprises:
applying respective forces to the wall portion either discontinuously or continuously in an order from a base of the wall portion to a top of the wall portion or from the top of the wall portion to the base of the wall portion.

7. The riveting method of claim 1, wherein the step of applying a force to the wall portion comprises:
applying at a first level of the wall portion respective forces to the wall portion discontinuously or continuously during a first circumferential movement of a tool for applying such forces along the wall portion; and
applying at a second level of the wall portion respective forces to the wall portion discontinuously or continuously during a second circumferential movement of the tool for applying such forces along the wall portion.

8. The riveting method of claim 1, wherein the step of applying a force to the wall portion comprises:
using a tool to apply a first force to the wall portion so that a deformed portion recessed toward the fastener is generated on the wall portion; and
placing the tool in the deformed portion against the wall portion, and moving the tool from one side of the deformed portion to the other side of the deformed portion along the wall portion, wherein the tool abuts against the wall portion during the movement of the tool to apply forces on the wall portion.

9. The riveting method of claim 8, wherein the tool has a first axis and the tool further has a cross section perpendicular to the first axis, wherein the cross section is either a regular cross section or an irregular cross section.

10. The riveting method of claim 9, wherein the regular cross section is one or a combination of a circular cross section, an elliptical cross section, and a polygonal cross section.

11. The riveting method of claim 9, wherein the irregular cross section includes a varied cross-section along the axis of tool.

12. The riveting method of claim 1, wherein the tool has a first axis and the tool is configured to rotate about the first axis during a movement of the tool along the wall portion, to avoid or reduce a friction between the tool and the wall portion.

13. The riveting method of claim 11, wherein a trajectory of the first axis is a regular trajectory or an irregular trajectory during the movement of the tool along the wall portion.

14. The riveting method of claim 12, wherein the regular trajectory is one of a circular, elliptical, polygonal, or zigzag shape.

15. The riveting method of claim 1, wherein the recessed area is formed by one of the following methods: machine tool machining, powder metallurgy technology, 3D printing, electric discharge machining, forging and casting.

16. The riveting method of claim 1, wherein the recessed area has a regular shape or an irregular shape.

17. The riveting method of claim 15, wherein the regular shape is one or a combination of a circular, elliptical, or polygonal shape.

18. The riveting method of claim 1, wherein the step of applying a force to the wall portion comprises:
using a tool to apply forces to the wall portion, wherein the tool has a plurality of abutting portions for abutting the wall portion, and the plurality of abutting portions are distributed around the wall portion at either an equal interval or unequal intervals.

19. The riveting structure of claim 1, wherein the fastener comprises a head and a shaft that are connected to each other and the head is configured to be placed in the recessed area so as to be enclosed by the wall portion after the wall portion is deformed.

20. The riveting structure of claim 19 wherein the head and/or the shaft perpendicular to an axis of the fastener has a regular-shaped cross section or an irregular-shaped cross section and wherein the regular shape is one or a combination of a circular, a polygonal, or an elliptical shape.
